(19) United States
(12) Patent Application Publication
(10) Pub. No.: US 2023/0136024 A1
(43) Pub. Date: May 4, 2023

(54) Field Device, Measuring Assembly and Method for Providing an Output Signal

(71) Applicant: VEGA GRIESHABER KG, Wolfach (DE)

(72) Inventors: Günter Kech, Wolfach (DE); Jürgen Haas, Oberwolfach (DE); Fabian Rank, Gutach (DE); Natalie Waldecker, Ortenberg (DE)

(21) Appl. No.: 17/893,381

(22) Filed: Aug. 23, 2022

(30) Foreign Application Priority Data
Nov. 4, 2021 (EP) 21206573.4

(51) Int. Cl. G01D 21/02; G06F 13/38

(52) U.S. Cl. CPC G01D 21/02; G06F 13/382

(57) ABSTRACT

A field device with a two-wire supply interface suitable for receiving energy via a two-wire system and for signal transmission via the two-wire system, an integrated sensor, at least one additional interface suitable for signal reception and a functional unit or functional group for data and/or signal processing, which is coupled to the two-wire supply interface, the additional interface and the integrated sensor, as well as a measuring assembly with a field device and a method for providing an output signal.

### CROSS REFERENCE TO RELATED APPLICATIONS

This patent application claims priority to European Patent Application 21206573.4, filed on Nov. 4, 2021.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention comprises a field device with a two-wire supply interface, which is suitable for receiving energy via a two-wire system and for signal transmission via the two-wire system, with an integrated sensor, with at least one additional interface, which is suitable for signal reception, and with a functional unit or functional group for data and/or signal processing, which is coupled to the two-wire supply interface, the additional interface and the integrated sensor. The invention further comprises a measuring assembly and a method for providing an output signal.

### Background of the Invention

Various technical devices that are directly related to a production process are subsumed under the term field device. Here, “field” refers to the area outside of control centers. Thus, examples of field devices comprise actuators, sensors and measuring transducers. Field devices that serve for determining and/or influencing process variables are often used in process automation engineering. Filling level measuring devices, limit level measuring devices and pressure measuring devices with sensors determining the respective process variables filling level, limit level or pressure are examples of such field devices. Typical areas of use of such field devices include areas such as flood forecasting, inventory management or also other decentralized measuring tasks.

A two-wire field device is understood to be a field device which is connected to a higher-level unit via two wires, wherein both an energy supply and a transmission of measurement values takes place via these two wires. The energy and/or signal transmission between such a field device and the higher-level units is generally carried out in accordance with the known 4 mA to 20 mA standard, in which a 4 mA to 20 mA current loop, i.e. a two-wire line, is formed between the field device and the higher-level unit. In addition to the analog transmission of signals, there is the option of the field devices transmitting further information to the higher-level unit, or receiving it therefrom, in accordance with various other protocols, particularly digital protocols. The HART protocol or the Profibus PA protocol may be mentioned as examples in this respect.

Compared with four-wire field devices, for example, field devices supplied only by a two-wire system require a considerably reduced installation and wiring effort. In such two-wire field devices, the additional installation and wiring of a supply voltage can be completely dispensed with because it takes place via the two-wire line, as shown above. Particularly in the case of applications in which explosion protection directives have to be observed, this provides considerable advantages because the separate wires for the supply voltage and the additional components required therefor are to be taken into account already during planning.

Two-wire field devices can be configured in an intrinsically safe manner and thus have an expanded field of application in explosion-protected (ex) regions. Maintenance work on field devices in ex regions are significantly easier and safer in the case of two-wire field devices than, for example, in four-wire field devices because they can safely take place even during a measuring operation. In four-wire devices, however, the energy supply must first be interrupted and secured against being turned back on again. Generally, this takes place in the terminal compartments, which are often located at a great distance from the measurement point.

A modular measuring system for radiometric measurements is known from US 2018/0203135 A1. The modular measuring system has a two-wire interface. A radiometric sensor is disposed in a base module of the measuring system. An expansion module of the measuring system is equipped with additional interfaces, via which the modular measuring system receives measurement values or is supplied with energy, for example.

In order to evaluate additional sensor information for determining a measurement value, it would be necessary to equip a field device with an additional hardware unit for measurements, which would require an additional supply terminal. The connection via a four-wire system would also be conceivable. That being said, it is the object of the invention to provide a field device that has the above-mentioned advantages of a two-wire field device, is capable of processing additional sensor information and nevertheless has a simple structure. It is another object of the invention to provide a measuring assembly with such a field device. Moreover, it is an object of the invention to specify a method which is suitable for determining an output signal on the basis of sensor information by means of a simple structure and to output it via a two-wire system.

The objects are achieved by specifying the field device, measuring assembly and method for providing an output signal, each as described herein. Various mutually independent advantageous developments of the present invention are also disclosed, whose features can be freely combined with each other by the person skilled in the art within the context of what is technically feasible.

### BRIEF SUMMARY OF THE INVENTION

In a preferred embodiment, ______

### BRIEF DESCRIPTION OF THE DRAWINGS

FIG. 1 is a line drawing showing a schematic representation of a field device according to the invention in an internal view.

FIG. 2 is a schematic drawing showing a representation of a first application scenario with a first measuring assembly.

FIG. 3 is a line drawing showing a connection diagram of the first measuring assembly.

FIG. 4 is a schematic drawing showing a representation of a second application scenario with a second measuring assembly.

FIG. 5 is a line drawing showing a connection diagram of the second measuring assembly.

FIG. 6 is a schematic drawing showing a representation of a third application scenario with a third measuring assembly.

FIG. 7 is a flow diagram of the method according to the invention.

### DETAILED DESCRIPTION OF THE INVENTION

According to an aspect of the invention, a field device of the type mentioned in the introduction is proposed, wherein the functional unit or functional group of the field device is configured for carrying out the following steps: receiving at least one first input signal from the integrated sensor, receiving at least one second input signal from the additional interface, generating an output signal on the basis of the at least one first input signal and the at least one second input signal. One advantage of this solution is that the costs are comparatively low, because no additional electronics or, for example, a more elaborate housing are required. Also, an intrinsically safe configuration is possible with the solution. Indeed, the field device according to an advantageous embodiment of the invention is configured in an intrinsically safe manner.

A signal is a sign with a certain meaning that the signal obtains by convention or definition. Information can be transported by a signal. According to the invention, the at least one first input signal, the at least one second input signal and the output signal may be digital and/or analog signals. For example, a density measured by the integrated sensor may be represented by an electrical voltage or be transmitted in the form of a digital data packet. The first input signal and the second input signal preferably represent measurement values. The output signal preferably also represents a measurement value, e.g. a corrected or compensated measurement value, or a measurement value otherwise adjusted or processed by the field device.

Advantageously, the integrated sensor is a sensor disposed in or on a housing of the field device. Fundamentally, the integrated sensor may be a sensor of any type. The output signal is generated such that both the first input signal and the second input signal are used for generating or computing the output signal. It is particularly advantageous, for instance, if the second input signal is used for correcting the first input signal. According to embodiments of the invention, it is possible that, in order to generate the output signal from the first input signal and the second input signal, the first input signal and/or the second input signal are processed, converted or otherwise handled. An interface within the sense of the present invention may be a unit for transmitting energy and/or data, such as a transceiver or the like, however, an interface may also be configured in a much simpler manner, according to the invention, and may merely be formed by a terminal or terminals, clamps or the like.

According to the invention, it is also possible that the field device, in addition to the additional interface, also has at least one further interface. Via the at least one further interface, at least one further measurement value may optionally be recorded and used as a basis for generating the output signal. According to other embodiments, the further interface is used for outputting a value, e.g. a signal that is outputted if a specific measurement value appears. For example, a signal may be outputted if the first input signal, the second input signal and/or the output signal assume or exceed a certain value. Moreover, it is possible that at least one predefined value, which is used for generating the output signal, is stored in the output signal. The predefined value may be, for example, a natural constant or a property, which remains approximately constant, of a medium or object examined by means of the field device. The functional unit or functional group of the field device is preferably a CPU, a microcontroller, a computing unit of another type, or a group of computing and/or signal processing components. The functional unit or functional group may, but does not have to, comprise peripheral components, e.g. analog-to-digital converters or digital-to-analog converters. A functional group of the field device may also be implemented, in particular, by a system-on-chip. According to the invention, the functional unit or functional group may be directly or indirectly coupled to the two-wire supply interface, the additional interface and/or the integrated sensor.

It is advantageous if the functional unit or functional group is configured for carrying out the following step: causing a transmission of the output signal via the two-wire system by means of the two-wire supply interface. In this way, additional interfaces for outputting the output signal may be omitted, and the existing two-wire supply interface may also be used for signal transmission.

It is advantageous if the additional interface is a two-wire interface. Advantages of the connection of a field device via a two-wire interface were already mentioned in the introduction. Preferably, the field device is configured such that it can receive the at least one second input signal via the additional interface. According to the invention, it is also possible that the field device is capable of outputting data via the additional interface, e.g. for the configuration of a device connected to the field device via the additional interface.

Preferably, the additional interface is suitable for supplying energy. Thus, a device connected to the field device, such as a sensor, may be supplied with voltage or current. According to one embodiment, the field device may obtain via the two-wire supply interface the energy provided to the connected device. Alternatively or additionally, the field device may include an energy storage device, such as a battery or the like, which is provided for supplying the connected device with energy. According to other embodiments, the connected device itself is either equipped or connected with an energy storage device, which does not belong to the field device.

Preferably, the two-wire supply interface and/or the at least one additional interface are suitable for receiving and/or transmitting signals in accordance with the standard DIN IEC 60381-1, the standard DIN IEC 60381-2, dem Profibus PA protocol and/or the HART protocol. The standard DIN IEC 60381-1defines the transmission of data via analog direct current signals, which are also used for supplying energy. Particularly version DIN IEC 60381-1:1985-11 of the standard is advantageous. The standard DIN IEC 60381-2 defines the transmission of data via analog voltage signals. Particularly version DIN IEC 60381-2:1980-06 of the standard is advantageous. Profibus (Process Field Bus) is a field bus protocol. The Profibus PA protocol permits a digital signal transmission. The HART protocol is based on the 4/20 mA standard and is also suitable for digital signal transmission. According to other variants of the invention, the signal and/or energy transmission via the two-wire supply interface may also take place in accordance with other standards or protocols.

According to the invention, it may be provided that more than one computing method is stored in the field device, which can be carried out for generating the output signal, wherein different computing methods are provided for external signal generators of different types connected to the additional interface. Thus, it is possible, as required, to connect different external signal generators to the field device and to generate the output signal on this basis. According to the invention, the external signal generator is supposed to be understood to be an external measuring device or an external sensor, e.g. even another field device. However, it may also be understood to be any other device that supplies a measurement or data value, or generates a processable signal that can be used for generating the output signal. According to one embodiment, the signal generator could be a regulating or controlling unit of a conveyor belt, for example, which provides the field device with a belt speed of the conveyor belt.

Preferably, the additional interface has exactly one pair of terminals, wherein the field device is configured for tapping the second input signal from the pair of terminals. Thus, the field device has a compact configuration, and different external signal generators can be connected to the pair of terminals as required. Preferably, the pair of terminals is formed by two clamps. As was explained above, the field device, depending on the connected external signal generator, can make use of different computing methods or algorithms for generating the output signal.

Alternatively, it is possible that the additional interface has several pairs of terminals, wherein the field device is configured for tapping the second input signal from one of the pairs of terminals. Thus, the additional interface has several pairs of terminals, and the second input signal may be tapped selectively, as required, from one of the pair of terminals. For this purpose, the field device may have a multiplexer, for instance, or the functional unit or functional group may have several inputs whose input signals may be processed selectively. According to the invention, the pairs of terminals may be pairs of clamps.

According to the invention, it is possible that the first input signal represents a density. A density can be measured by means of a density sensor, such as a flexural resonator, which determines a natural frequency of a medium to be examined. The density of the medium can be derived from the natural frequency. However, density sensors of other types may also be used. In order to correctly determine the density, however, it is additionally necessary in many measuring methods to know the temperature of the medium to be examined.

According to a special embodiment, the second input signal represents a temperature measurement value, and the functional unit or functional group is configured for carrying out a temperature compensation of the first input signal by means of the second input signal during the generation of the output signal. This advantageous particularly if the first input signal represents a density. But also when determining other substance properties, it may be advantageous to carry out a temperature compensation. This means that a temperature compensation by means of a second input signal representing a temperature measurement value is advantageous also in the case of first input signals of a different type.

It is advantageous if the first input signal represents at least one dimension of an observed object, or if the at least one dimension of the object can be derived from the first input signal. The dimension of the observed object is supposed to be understood as its extent in space; for example, it may be its height, width or depth. If bulk material is transported on a conveyor belt, for example, then a height of the bulk material may be determined when observing it from the side with an optical sensor. It is also possible that a dimension of the object can be derived from the measurement value. For example, a height of the object can be derived by means of suitable data processing steps from input signals constituting an optical representation of the observed object, such as a camera image. According to the invention, it is possible that corresponding evaluation processes and/or computations are carried out by the functional unit or functional group. Thus, the field device is preferably suitable for deriving the at least one dimension of the object from the at least one first input signal.

It is particularly advantageous if the second input signal represents a flow velocity or transport velocity of a material, wherein the functional unit or functional group is configured for determining as the output signal a mass of the material or a mass flow, based on the first input signal and the second output signal. Frequently, a transported mass is to be determined. It is also possible that a mass flow is to be determined, i.e. the transported mass per unit time. This cannot be determined solely on the basis of the knowledge of a density of the material or the height of an object. It is also necessary to know how fast the material is being transported. The material may be, for example, bulk material on a conveying belt whose transport velocity is to be determined. Alternatively, it may be the flow velocity of a material through a pipe. In order to determine the mass of the material, it may be necessary in both cases, according to embodiments, that for the purpose of computation some parameters are previously known or are estimated.

Consider the case that a mass transported in a pipe is estimated based on a measured density and a flow velocity. In this case, a cross-sectional surface area A of the pipe is supposed to be known. With a flow velocity ν and a density ρ, the mass flow qₘ is given by qₘ=ρ*A*ν. In the case where bulk material is transported on a conveyor belt and its height h is measured, its average extent in the width direction w on the conveying belt and its average density p have to be estimated in advance. It a transport velocity ν is provided as a second input signal to the field device, a mass flow qₘ can be computed in accordance with qₘ=ρ*w*h*ν. In both cases, the transported mass is determined by integrating the mass flow over time. However, in other embodiments of the invention, other parameters may be previously known, or it is also possible that additional parameters are supplied by external signal generators and are additionally used for generating the output signal.

According to another aspect of the invention, a measuring assembly is proposed, with a field device of the above-described type, and with a signal generator, wherein the field device is connected via the additional interface of the field device to the signal generator. The signal generator is to be understood to be any device that can supply the field device with a signal, e.g. a sensor or a control unit. The signal generator preferably generates the second input signal that is evaluated by the field device. The signal generator is preferably connected to the field device via a two-wire system. Preferably, the signal generator is not a part of the field device, and/or the signal generator is preferably disposed outside a housing of the field device.

According to a possible embodiment of the invention, the signal generator is a temperature sensor. In particular, the temperature sensor may be an RTD sensor. Using the temperature sensor, a temperature correction may take place of a value on which the first input signal is based and which the field device determines by means of its integrated sensor. A temperature-corrected output signal can thus be generated by the field device.

It is advantageous if the signal generator is a flow sensor or a control device of a transport system. In a corresponding embodiment, the signal generator is suitable for measuring or indicating how fast a liquid, for example, flows through a pipe, or how fast a bulk material is transported by a conveyor belt. If the integrated sensor of the measuring assembly determines a density, or determines at least one dimension of an observed object, then a mass flow in the pipe or on the conveyor belt can be computed on this basis.

According to another aspect of the invention, a method is proposed for providing an output signal, with the steps: generating at least one first input signal by an integrated sensor of a field device, receiving at least one second input signal by the field device from a signal generator external to the field device, generating the output signal by the field device on the basis of the at least one first input signal and the at least one second input signal, and causing a transmission of the output signal via a two-wire system by means of a two-wire supply interface of the field device. According to the invention, the external signal generator may generate the at least one second input signal. It should be understood that the above-described field device or the above-described measuring assembly can be used for generating the output signal. However, the method is not limited to the implementation using such a field device or such a measuring assembly.

One variant of the method is particularly advantageous, in which the at least one first input signal represents a density and the at least one second input signal represents a temperature, and wherein a temperature compensation of the at least one first input signal by means of the at least one second input signal is carried out during the generation of the output signal. Thus, the output signal is a compensated density. According to another advantageous embodiment, the at least one first input signal represents a density, and the at least one second input signal represents a flow velocity or transport velocity of a material, wherein a mass or mass flow of the material is determined during the generation of the output signal. According to another advantageous embodiment, the at least one first input signal represents at least one dimension of an object, or the at least one dimension of the object can be derived from the at least one first input signal, and the at least one second input signal is a flow velocity or transport velocity of the object, wherein a mass or mass flow of the object is determined during the generation of the output signal. In order to determine the mass or mass flow of the material or object, additional parameters or input values may possibly be required. According to embodiments of the invention, these values can be previously defined or determined. According to other embodiments of the invention, these values can be generated by means of additional measurement value generators while carrying out the method and provided to the field device, so that these values can be taken into account when generating the output signal.

### Detailed Description of the Figures

FIG. 1 shows a schematic representation of a field device 1 according to the invention in an internal view. The field device 1 has a housing 2. It is equipped with a two-wire supply interface 3. Via the two-wire supply interface 3, the field device 1 can be supplied with electrical energy from a higher-level unit, and the field device 1 can output an output signal via the two-wire supply interface 3 to the higher-level unit. This occurs in accordance with the standard DIN IEC 60381-1. The field device 1 has a functional unit 4, which is a microcontroller. The microcontroller is connected with the two-wire supply interface 3 and with an additional interface 5 of the field device 1. The additional interface 5 is provided for establishing a connection with a temperature sensor.

The field device 1 further has an integrated sensor 6, which is a density sensor operating in accordance with the principle of the flexural resonator. In the process, a vibrating fork 7 of the integrated sensor 6 is excited, and a natural frequency of a surrounding medium is determined in this manner. The density of the surrounding medium can be determined in this manner. The functional unit 4 is also connected with the integrated sensor 6. During the operation of the field device 1, the functional unit 4 receives a first input signal from the integrated sensor 6 and a second input signal via the additional interface 5. It generates an output signal on the basis of the first input signal and the second input signal and then causes a transmission of the output signal by means of the two-wire supply interface 3. The first input signal is a density of the surrounding medium, which is temperature-compensated by means of the second input signal, which is a temperature of the surrounding medium. Thus, a temperature-compensated density can be determined and outputted via the two-wire supply interface 3 of the field device 1.

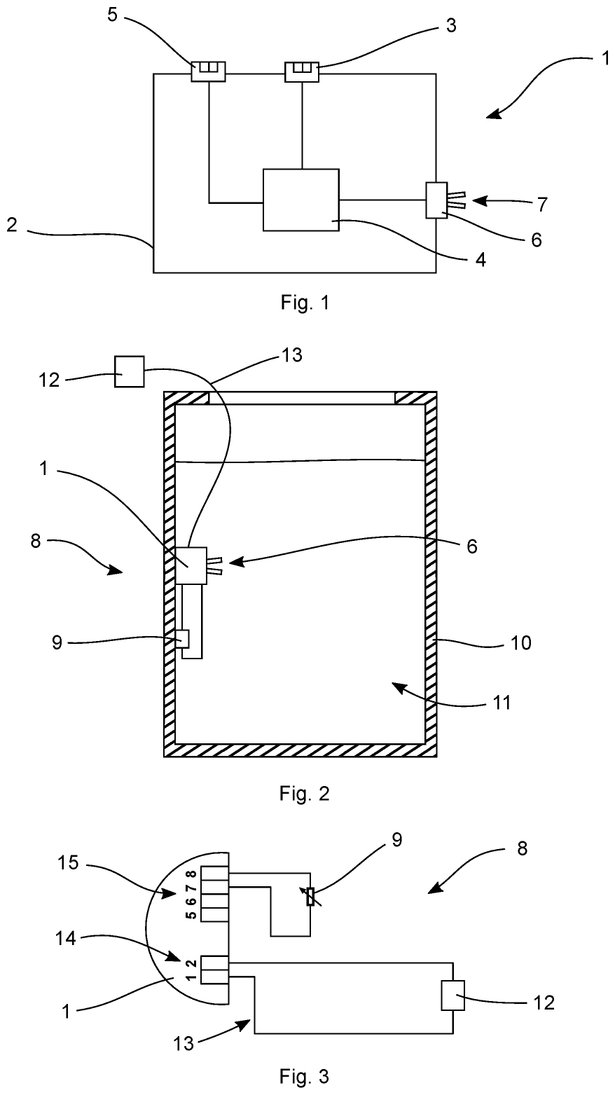

FIG. 2 shows a schematic representation of a first application scenario with a first measuring assembly 8. The first measuring assembly 8 has a field device 1, whose integrated sensor 6 is a density sensor. A temperature sensor 9 is connected to an additional interface of the field device 1. Both the field device 1 and the temperature sensor 9 are disposed in a container 10 in which a medium 11 is located. A higher-level unit 12, which is a monitoring and supply system, is connected to the field device 1 via a two-wire system 13 (here, both wires of the two-wire system 13 are routed together), wherein the higher-level unit 12 supplies the field device 1 with electrical energy via the two-wire system 13. In order to determine the density of the medium 11, the field device 1 performs a density measurement by means of the integrated sensor 6 and a temperature measurement by means of the temperature sensor 9. The field device 1 carries out a temperature compensation of a result of the density measurement by means of a measured temperature of the medium. A compensated density resulting in the process is transmitted as an output signal to the higher-level unit 12 via the two-wire system 13 by means of a two-wire supply interface of the field device 1.

FIG. 3 shows a connection diagram of the first measuring assembly 8. The field device 1 has first clamps 14, by means of which it is connected to the higher-level unit 12 via the two-wire system 13. Both communications and the energy supply of the field device 1 via the two-wire system 13 take place in accordance with the standard DIN IEC 60381-1. The field device 1 further has second clamps 15 to which the temperature sensor 9 is connected. The temperature sensor 9 is an RTD sensor. A temperature-dependent resistance is measured in the RTD sensor by the field device 1 sending a defined measuring current into the temperature sensor 9 and internally determining a voltage drop at the RTD sensor. Based on the voltage, a temperature of the medium can be determined indirectly, so that the above-described temperature compensation can take place. A density determined by the integrated sensor constitutes a first input signal, and the voltage drop at the RTD sensor constitutes a second input signal. The output signal is determined on the basis of the first input signal and the second input signal.

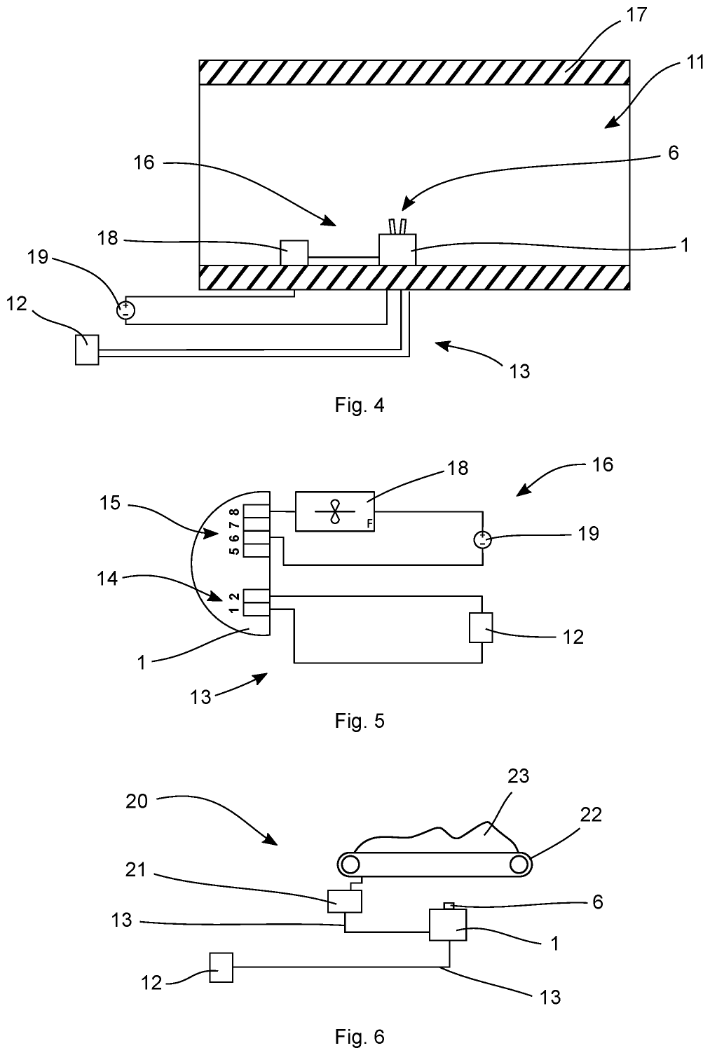

FIG. 4 shows a schematic representation of a second application scenario with a second measuring assembly 16. In the second measuring assembly 16, a field device 1 and a flow sensor 18 are arranged in a pipe 17 through which a medium flows 11. The flow sensor 18 is connected to an additional interface of the field device 1 and connected in series with a voltage source 19. The voltage source 19 is arranged outside the pipe 17. The field device 1 has an integrated sensor 6, which is a density sensor. The integrated sensor 6 determines a density of the medium 1 as a first input signal. The flow sensor 18 determines a flow velocity of the medium 11 as a second input signal. Since a cross-sectional surface area of the pipe 17 is known, a computing unit of the field device 1 can compute a mass flow in the pipe from the first input signal and the second input signal. A higher-level unit 12 is connected in a communicating manner to the field device 1 via the two-wire system 13, so that the field device 1 can transmit the mass flow to the higher-level unit in the form of an output signal. The two-wire system 13 is connected to the field device 1 via a two-wire supply interface. Moreover, the higher-level unit 12 supplies the field device 1 with electrical energy via the two-wire system 13.

FIG. 5 shows a connection diagram of the second measuring assembly 16. The field device 1 has first clamps 14, via which the field device 1 is connected to the higher-level unit 12. Communications via the two-wire system 13 take place in accordance with the standard DIN IEC 60381-1. The field device 1 further has second clamps 15 to which the flow sensor 18 is connected. The voltage source 19 connected in series with the flow sensor 18 supplies the flow sensor 18 with an operating voltage necessary for the latter. The second clamps 15 are operated as a passive current input. However, the integrated sensor of the field device 1 is not supplied by the voltage source 19; it is exclusively supplied with energy by the higher-level unit 12 via the two-wire system 13.

FIG. 6 shows a schematic representation of a third application scenario with a third measuring assembly 20. A field device 1 is connected via a first two-wire system 13 to a higher-level unit 12, which supplies the field device 1 with electrical energy. The field device 1 is connected via a second two-wire system 13 to a control device 21 of a conveyor belt 22. The connection via the two two-wire systems 13 is implemented in accordance with the standard DIN IEC 60381-1. The field device 1 has an integrated sensor 6, which is a camera. A microcontroller within the field device 1 obtains from the integrated sensor 6 first input signals, which represent images of bulk material 23 on the conveyor belt 22. The control device 21 knows a belt speed of the conveyor belt 22 and transmits it to the field device 1. The belt speed is received at the microcontroller in the form of second input signals. The microcontroller derives a respective height of the bulk material 23 from the first input signals. Based on the belt speed, an assumed average density of the bulk material as well as an assumed average extent of the bulk material 23 in the width, the microcontroller computes a mass transported by the conveyor belt 22 and outputs it in the form of an output signal to the higher-level unit 12 via the first two-wire system 13.

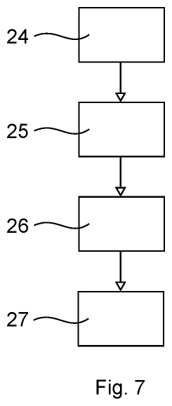

FIG. 7 shows a flow diagram of the method according to the invention. In a measuring step 24, an integrated sensor of a field device generates a first input signal during a measurement, e.g. during a density measurement. In a receiving step 25, the field device receives a second input signal from a signal generator external to the field device. The external signal generator may be an external sensor, for instance. In a generating step 26, the field device generates an output signal on the basis of the first input signal and the second input signal. According to the invention, the generating step can be carried out by a microcontroller or other functional unit or functional group for data and/or signal processing of the field device. In an outputting step 27, the field device transmits the output signal via a two-wire system by means of a two-wire supply interface of the field device. A higher-level unit, such as a monitoring computer, can receive the output signal via the two-wire interface.

### LIST OF REFERENCE NUMBERS

1 Field device
2 Housing
3 Two-wire supply interface
4 Functional unit
5 Additional interface
6 Integrated sensor
7 Vibrating fork
8 First measuring assembly
9 Temperature sensor
10 Container
11 Medium
12 Higher-level unit
13 Two-wire system
14 First clamps
15 Second clamps
16 Second measuring assembly
17 Pipe
18 Flow sensor
19 Voltage source
20 Third measuring assembly
21 Control device
22 Conveyor belt
23 Bulk material
24 Measuring step
25 Receiving step
26 Generating step
27 Outputting step

Unless indicated otherwise, identical reference numbers in the figures identify identical components with the same function. The terms drive unit and drive are used interchangeably herein.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A field device with a two-wire supply interface, which is suitable for receiving energy via a two-wire system and for signal transmission via the two-wire system, with an integrated sensor, with at least one additional interface, which is suitable for signal reception, and with a functional unit or functional group for data and/or signal processing, which is coupled to the two-wire supply interface, the additional interface and the integrated sensor, wherein the functional unit or functional group is configured for carrying out the following steps:
receiving at least one first input signal from the integrated sensor,
receiving at least one second input signal from the additional interface, and
generating an output signal on the basis of the at least one first input signal and the at least one second input signal.

2. The field device according to claim 1, wherein the functional unit or functional group is configured for carrying out the following step:
causing a transmission of the output signal via the two-wire system by means of the two-wire supply interface.

3. The field device according to claim 1, wherein the additional interface is a two-wire interface.

4. The field device according to claim 1, wherein the additional interface s suitable for supplying energy.

5. The field device according to claim 1, wherein the two-wire supply interface and/or the at least one additional interface are suitable for receiving and/or transmitting signals in accordance with the standard DIN IEC 60381-1, the standard DIN IEC 60381-2, dem Profibus PA protocol and/or the HART protocol.

6. The field device according to claim 1, characterized in that more than one computing method is stored in the field device which can be carried out for generating the output signal, wherein different computing methods are provided for external signal generators of different types connected to the additional interface.

7. The field device according to claim 1, wherein the additional interface has exactly one pair of terminals, wherein the field device is configured for tapping the second input signal from the pair of terminals.

8. The field device according to claim 1, wherein the additional interface has several pairs of terminals, wherein the field device is configured for tapping the second input signal from one of the pairs of terminals.

9. The field device according to claim 1, wherein the first input signal represents a density.

10. The field device according to claim 1, wherein the second input signal represents a temperature measurement value, wherein the functional unit or functional group is configured for carrying out a temperature compensation of the first input signal by means of the second input signal during the generation of the output signal.

11. The field device according to claim 1, wherein the first input signal represents at least one dimension of an observed object, or the at least one dimension of the observed object can be derived from the first input signal.

12. The field device according to claim 9, wherein the second input signal represents a flow velocity or transport velocity of a material, wherein the functional unit or functional group is configured for determining as the output signal a mass of the material or a mass flow, based on the first input signal and the second output signal.

13. A measuring assembly with a field device according to claim 1 and with a signal generator, wherein the field device is connected via the additional interface with the signal generator.

14. The measuring assembly according to claim 10, wherein the signal generator is a temperature sensor.

15. The measuring assembly according to claim 13, wherein the signal generator is a flow sensor or a control device of a transport system.

16. A method for providing an output signal comprising the steps:
generating at least one first input signal by an integrated sensor of a field device,
receiving at least one second input signal by the field device from a signal generator external to the field device,
generating the output signal by the field device on the basis of the at least one first input signal and the at least one second input signal, and
causing a transmission of the output signal via a two-wire system by means of a two-wire supply interface of the field device.

17. The measuring assembly according to claim 13, wherein the signal generator is a temperature sensor.
